(19) United States
(12) Patent Application Publication
(10) Pub. No.: US 2021/0340041 A1
(43) Pub. Date: Nov. 4, 2021

(54) STORMWATER FILTER UTILIZING A HYDROPONIC BED AS FILTERING COMPONENT

(71) Applicants: Stuart C. Ellis, Apison, TN (US); Eric B. Rominger, Hixson, TN (US); J. Kelly Williamson, Hixson, TN (US)

(72) Inventors: Stuart C. Ellis, Apison, TN (US); Eric B. Rominger, Hixson, TN (US); J. Kelly Williamson, Hixson, TN (US)

(73) Assignee: AquaShield, Inc., Chattanooga, TN (US)

(21) Appl. No.: 17/300,231

(22) Filed: Apr. 20, 2021

Related U.S. Application Data
(60) Provisional application No. 63/101,481, filed on May 1, 2020.

(51) Int. Cl. C02F 3/32; C02F 1/00; B01D 24/22; B01D 24/24; B01D 39/04; B01D 39/06

(52) U.S. Cl. CPC C02F 3/327; C02F 1/004; B01D 24/22; C02F 2103/001; B01D 39/04; B01D 39/06; B01D 24/24

(57) ABSTRACT

A stormwater filter includes a receptacle having an open top into which stormwater is permitted to enter the receptacle and flow downwardly therein. A hydroponic garden section having a media bed is supported within the receptacle and in an elevated condition above the bottom of the receptacle so that a water sump compartment is disposed between the hydroponic garden section and the bottom of the receptacle. In addition, a discharge opening is defined within a sidewall of the receptacle in the water sump compartment and adjacent the hydroponic garden section, and a post-filtration flow control orifice is associated with the discharge opening for controlling the filtration flow through the media bed. In addition, a wick is associated with the media bed for drawing water upwardly from the water sump compartment for use by plants growing within the media bed.

The benefit of Provisional Application Ser. No. 63/101,481, filed May 1, 2020 and entitled STORMWATER FILTER UTILIZING A HYDROPONIC GARDEN AS FILTERING COMPONENT, is hereby claimed. The disclosure of this referenced provisional application is incorporated herein by reference.

### BACKGROUND OF THE INVENTION

This invention relates generally to the filtration of materials, such as sediment and contaminants, from stormwater which is routed toward drainage piping and relates, more particularly, to a stormwater treatment system for filtering stormwater prior to the entrance of the stormwater to the drainage piping.

Stormwater treatment systems are known which involve a post-construction, permanently-installed unit through which stormwater is directed and which utilize principles of hydrodynamic separation for filtration purposes. An example of such a stormwater treatment system is shown and described in U.S. Pat. No. 6,524,473.

As an alternative to such permanent, post-construction treatment systems and within “green infrastructure” (GI) stormwater management programs, it has become desirable to move toward the implementation of low impact development (LID) products as the preferred means to implement stormwater measures. It would be desirable to provide a new and improved stormwater treatment system in the class of LID products.

It is an object of the present invention to provide a new and improved stormwater filtration system in the class of LID products.

Another object of the present invention is to provide such a new and improved filtration system which combines the filtration aspect with the principles of hydroponic horticulture.

Still another object of the present invention is to provide such a new and improved filtration system which incorporates a hydroponic bed as a filtering component.

Yet still another object of the present invention is to provide such a filtration system whose design helps to control the flow rate of stormwater flowing through the system by way of a post-filtration flow control.

A further object of the present invention is to provide such a filtration system whose hydroponic bed includes perlite and/or other inorganic/organic media components.

A still further object of the present invention is to provide such a filtration system which is easily serviceable.

A yet still further object of the present invention is to provide such a filtration system which is uncomplicated in construction yet effective in operation.

### SUMMARY OF THE INVENTION

This invention resides in a stormwater filter including an open-topped receptacle into which stormwater is permitted to enter the receptacle through the open top thereof and flow downwardly therein; and the receptacle includes a bottom and sidewalls which extend upwardly from the bottom to the open top thereof. In addition, the filter includes a hydroponic section defining an upper surface and which is supported within the receptacle and in an elevated condition above the bottom thereof so as to provide a water sump compartment between the hydroponic section and the bottom of the receptacle. The hydroponic section includes a media bed which is capable of filtering stormwater which flows downwardly through the hydroponic section from the upper surface thereof. Furthermore, there is defined within a sidewall of the receptacle a discharge opening disposed within the water sump compartment and through which the filtered stormwater which is collected within the water sump compartment is permitted to exit the receptacle; and a wick is associated with the hydroponic section for drawing water upwardly from the water sump compartment into the media bed.

### BRIEF DESCRIPTION OF THE DRAWINGS

FIG. 1 is a perspective view of an embodiment of a stormwater filter within which features of the present invention are embodied and an exemplary environment within which the filter embodiment is employed.

FIG. 2 is a perspective view of the FIG. 1 filter embodiment, shown with plants removed therefrom.

FIG. 3 is a top plan view of the FIG. 1 filter embodiment.

FIG. 4 is a side view of the FIG. 1 filter embodiment as seen from below in FIG. 3.

FIG. 5 is a perspective view of the FIG. 1 filter embodiment of FIG. 1, shown exploded.

FIG. 6 is a cross-sectional view of the FIG. 1 filter embodiment taken about along line 6-6 of FIG. 3.

### DETAILED DESCRIPTION OF AN ILLUSTRATIVE EMBODIMENT

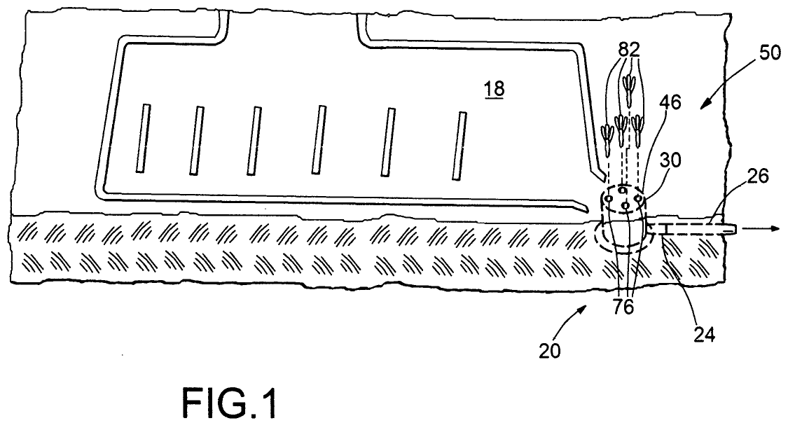

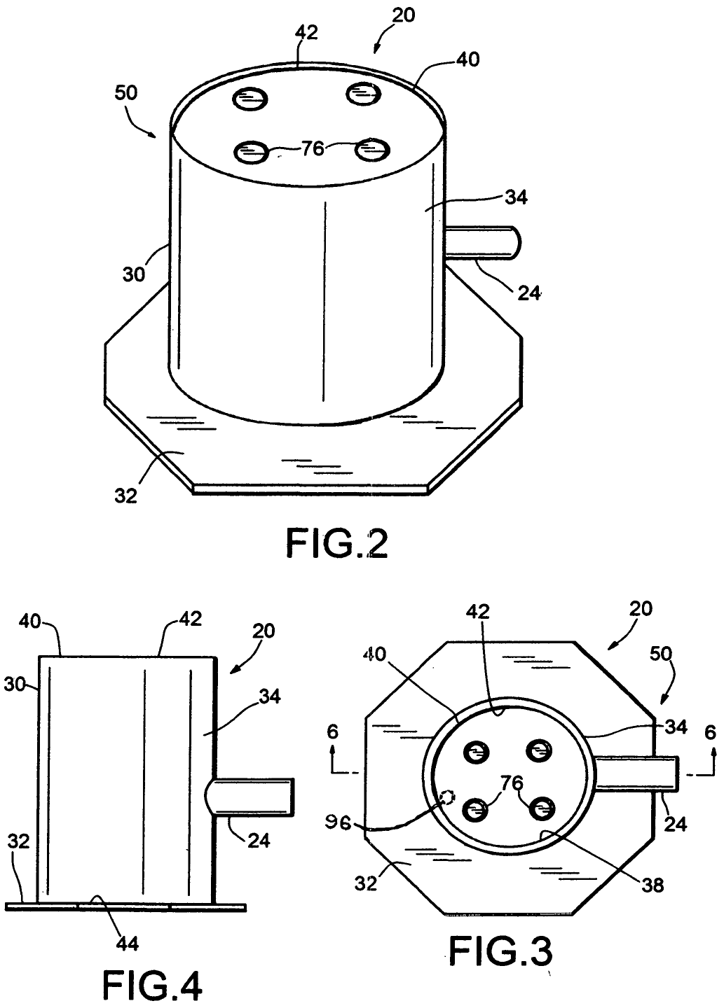

Turning now to the drawings and considering first FIGS. 1-5, there is illustrated an embodiment, generally indicated 20, of a stormwater filter within which features of the present invention are embodied. The illustrated filter 20 is intended for use in an application, such as is depicted in FIG. 1, showing a parking lot 18 whose natural drainage is designed to direct water (e.g. stormwater) which flows across the upper surface of the parking lot 18 toward a preselected (e.g. lowermost) corner of the lot 18 at which the filter 20 is installed. That is to say that the top of the filter 20 is disposed at a position adjacent the parking lot 18 at which the elevation of the lot 18 is at its lowest so that during a rainfall, the rain water will flow naturally across the upper surface of the lot 18 and toward the filter 20 for collection thereat. The filter 20, whose body is embedded below the surface of the ground, has a discharge conduit 24, described herein, which is connectable to appropriate (e.g. underground) drain piping 26 through which water which is collected at the filter 20 is permitted, under the appropriate conditions, to exit the filter 20 and flow along the drain piping 26.

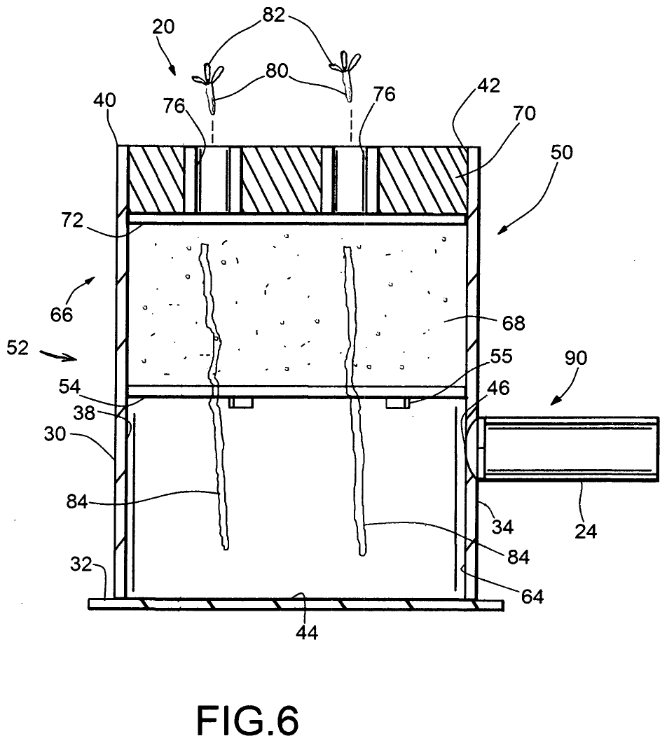

As will be apparent herein, it is also a feature of the filter 20 that it includes a hydroponic garden section 50 which is adapted to both filter stormwater which flows downwardly through the media comprising the garden section 50 and support plants 82 (FIGS. 1 and 6) for growth within such media.

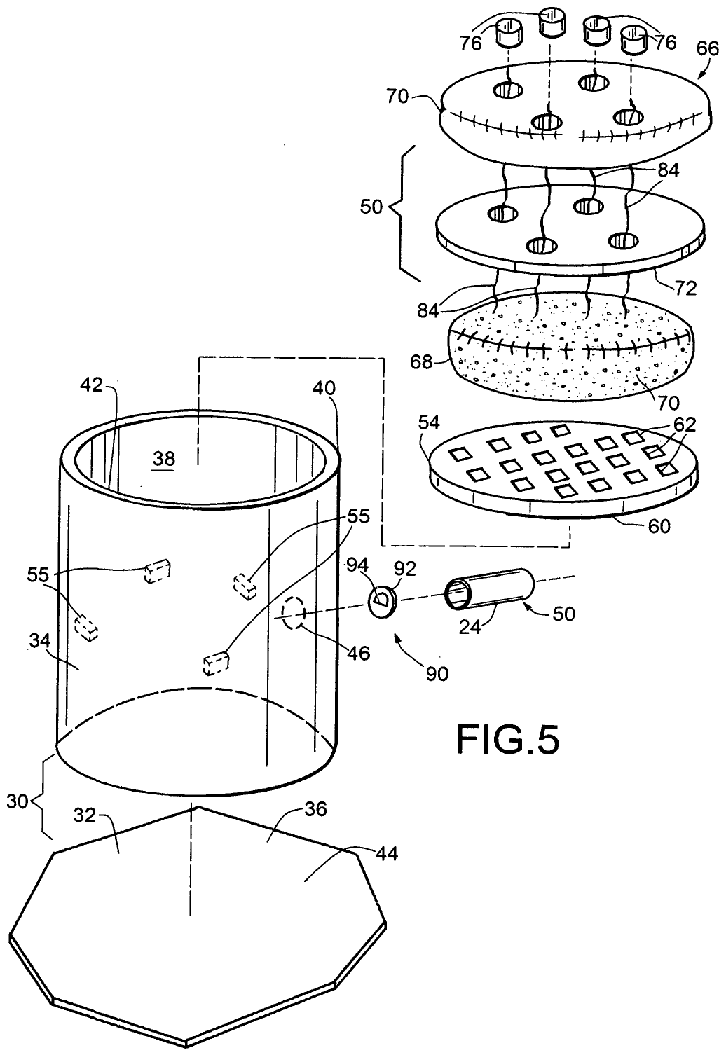

With reference again to FIGS. 1-5, the filter 20 includes an open-topped receptacle 30 including a platen base 32 and sidewalls 34 which are joined to so as to extend upwardly from the base 32 to a horizontally-disposed upper edge 40 which encircles the open top, indicated 42, of the receptacle 30. The sidewalls 34 encircle a mid-region 36 (FIG. 5) of the base 32 to provide a receptacle interior 38 having a circular cross-section (when viewed in the plan view of FIG. 3), and the mid-region 36 of the base 32 provides the bottom 44 of the receptacle 30. Meanwhile, a sidewall 34 of the receptacle 30 defines a discharge opening 46 (FIG. 5) which is spaced above the base 32 and through which water which is collected within the receptacle interior 38 is permitted to exit the receptacle 30. Associated with this discharge opening 46 is means, generally indicated 90 in FIG. 5, defining a post-filtration flow control (described herein) which controls the flow of water through the media bed of the hydroponic garden section 50.

To facilitate a connection between the discharge opening 46 and appropriate (e.g. underground) drain piping 26 (FIG. 1), a piece of discharge conduit 24 (introduced earlier) of substantially circular cross section has one end which is secured about the opening 46 and an opposite end which extends substantially horizontally from the opening 46 for securement to the drain piping 26 in an end-to-end relationship.

Although each component of the receptacle 30 can be constructed of any of a number of materials, such as fiberglass-reinforced plastic (FRP) or steel or concrete, the receptacle 30 of the depicted filter 20 is preferably fabricated of polymer coated steel (PCS) which promotes a relatively long useful life of the filter 20. In the alternative, the receptacle 30 can be fabricated out of durable high-density polyethylene (HDPE) materials. In either event, the materials comprising the receptacle 30 are preferably relatively light in weight so that the receptacle 30 can normally be off-loaded at a jobsite in a fully assembled condition without the need for special lifting equipment, such as a crane. Thus, the depicted receptacle 30 accommodates relatively easy on-site handling and installation.

With reference to FIGS. 5 and 6, the hydroponic garden section 50 of the filter 20 is supported in an elevated condition within the receptacle interior 38. To this end, the filter 20 includes means, generally indicated 52, for supporting the hydroponic garden section 50 at a desired elevation within the receptacle 30. Although the garden section 50 can be supported within the receptacle interior in any of a number of ways, the supporting means 52 of the depicted filter 20 includes a rigid, water-permeable plate 54 having a circular outer edge which is sized to be closely accepted by the open top 42 of the receptacle 30 when placed downwardly therein, and a plurality of bosses 55 are mounted to the interior surface of the sidewalls 34 and at regular spaced intervals therearound for supporting the plate 54 in a substantial horizontal orientation therein. To permit water to flow downwardly through the plate 54, the plate 54 can be comprised of a rigid (e.g. steel) platen 60 having a plurality of vertically-extending through-openings 62 disposed across the upper surface of the plate 60. In addition—and for a reason which will become apparent herein, the region of the receptacle interior 38 which is disposed between the bottom 44 of the receptacle 30 and the underside of the plate 54 provides a water sump compartment, indicated 64 in FIG. 6, of the filter 20.

With reference again to FIG. 6, the hydroponic garden section 50 of the filter 20 can take any of a number of forms, but the garden section 50 of the depicted filter 20 includes a multiple-layer media bed, indicated 66 in FIGS. 5 and 6, comprised of a bed, or layer 68, of perlite which is overlain by a bed, or layer 70, of pea gravel or other course medium (e.g. pieces of crushed or colored glass) which provides the upper surface of the garden section 50. If desired, the layers 68 and 70 can be maintained in a separated condition by way of a water-permeable (e.g. porous) partition 72 (FIG. 5) positioned between the layers 68 and 70. Furthermore, optional locator rings 76 (FIGS. 5 and 6) can be positioned within and disposed across the upper surface of the pea gravel layer 70 to provide a user with suggested locations at which plants 82 or, more specifically, the root portions 80 (FIG. 6) of the plants 82 can be inserted downwardly within the media bed 66 for growth therein in a relatively uniformly-spaced arrangement.

The perlite medium which comprises the layer 68 is an inert, porous and relatively lightweight substance commonly used as a hydroponic substrate. Furthermore and because perlite is a porous medium, it offers excellent water retention and drainage capabilities. In addition, perlite can be washed for reuse and does not decompose, thus rendering it a long lasting medium.

However, it will be understood that although the bed 68 of the depicted media bed 68 of the hydroponic garden section 50 is described herein as being comprised of perlite, the bed 68 can be comprised of any of a number of inorganic/organic filter mediums besides (or in addition to) perlite. Accordingly, the principles of the present invention can be variously applied.

It is also a feature of the hydroponic garden section 50 that it includes a plurality of wicks 84 wherein each wick 84 has an upper end which is embedded within the interior of the media bed, or layer, 68 and has a lower end which extends downwardly from the media bed interior of the hydroponic garden section 50 and relatively deep into the water sump compartment 64 of the receptacle 30, as best shown in FIG. 6. During use of the filter 20, the wicks 84 serve to draw water upwardly from the water sump compartment 64 for use by the plants 82. Within the depicted filter embodiment 20, there is provided one wick 84 for every two square feet of media bed (upwardly-facing) surface area of the hydroponic garden section 50, although alternative wick-to-surface area ratios can be had.

It follows from the foregoing that a filter embodiment 20 has been described which is capable of both filtering stormwater which flows downwardly into the open top 42 of the receptacle 30 and supports plants 82 for growth. To this end, the filter 20 utilizes a hydroponic garden section 50 which is supported in an elevated condition above the water sump compartment 64 of the receptacle 30, and the media bed 66 of the hydroponic garden section 50 is capable of accepting plants 82 planted therein for growth as well as for filtering stormwater which flows downwardly therethrough.

As mentioned earlier, the filter embodiment 20 also includes means, generally indicated 90 in FIG. 5, for defining a flow control associated with the discharge opening 46 of the receptacle 30. Although such a flow control means 90 can take any of a number of forms, the flow control means 90 of the depicted filter 20 includes a plate 92 which is arranged in a vertical plane disposed across the discharge opening 46 and which defines an orifice 94 (e.g. of semicircular shape) for controlling the flow rate of water which exits the water sump compartment 64. As an alternative, the orifice 94 could be formed by a circular opening of reduced diameter. In addition—and to enable the filter embodiment 20 to operate effectively as a stormwater filter, the medium of the hydroponic garden section 50 should preferably accommodate a (stormwater) loading rate of between about 5 to 10 gallons per square foot of the (upper) surface area of the filter medium.

A stormwater filtration system possessing the structure of the aforedescribed embodiment 20 was constructed for testing purposes. Such a test system possessed an inner diameter (as measured across the open top 42 of the receptacle 30) of two feet so as to possess a corresponding effective treatment area of 3.14 square feet, and the test system possessed a filter media 68 having a thickness (i.e. depth) of no less than about twelve inches. Testing of the test system over ten events at a hydraulic loading rate of seven gallons per minute per square foot of filter media surface area has resulted in an average removal efficiency of about eighty-two percent at an average influent concentration of 200.4 mg/L.

It will be understood that numerous modifications and substitutions can be had to the aforedescribed filter embodiment 20 without departing from the spirit of the invention. For example, the filter embodiment 20 can also include a vertically-oriented sight tube 96 (depicted in phantom in FIG. 3) which extends downwardly through the media bed 66 and which enables an operator to periodically check the level of water contained within the sump compartment 64. Accordingly, the aforedescribed embodiment 20 is intended for the purpose of illustration and not as limitation.

1. A stormwater filter comprising:
an open-topped receptacle into which stormwater is permitted to enter the receptacle through the open top thereof and flow downwardly therein, and the receptacle includes a bottom and sidewalls which extend upwardly from the bottom to the open top thereof;
a hydroponic section defining an upper surface and which is supported within the receptacle and in an elevated condition above the bottom thereof so as to provide a water sump compartment between the hydroponic section and the bottom of the receptacle, and wherein the hydroponic section includes a media bed which is capable of filtering stormwater which flows downwardly through the hydroponic section from the upper surface thereof;
a sidewall of the receptacle defines a discharge opening disposed within the water sump compartment and through which the filtered stormwater which is collected within the water sump compartment is permitted to exit the receptacle; and
a wick which is associated with the hydroponic section for drawing water from the water sump compartment into the media bed.

2. The filter as defined in claim 1 wherein the hydroponic section includes an amount of perlite.

3. The filter as defined in claim 1 wherein the hydroponic section includes a combination of organic and inorganic material.

4. The filter as defined in claim 1 wherein the hydroponic section includes a layer of pea gravel which provides the upper surface of the hydroponic section.

5. The filter as defined in claim 4 further comprising a plurality of plant locator rings disposed across the upper surface of the layer of pea gravel.

6. The filter as defined in claim 1 wherein the wick has an upper section which is secured within the media bed of the hydroponic section and a lower section which extends downwardly into the water sump compartment.

7. The filter as defined in claim 6 wherein the wick is one wick of a plurality of wicks associated with the media bed of the hydroponic section, and the number of wicks of the filter corresponds to the amount of surface are of the media bed.

8. The filter as defined in claim 1 further comprising means defining a post-filtration flow control orifice which is associated with the discharge opening of the receptacle for controlling the filtration flow through the media bed.

9. The filter as defined in claim 8 wherein the means defining the post-filtration flow control orifice is in the form of a flow control plate which is arranged in a substantially vertical plane adjacent the discharge opening, and the flow control plate defines an opening therein of substantially semi-circular shape.

10. The filter as defined in claim 1 further including a rigid, water-permeable plate which is supported across the receptacle and above the water sump compartment, and the hydroponic section is positioned atop the rigid, water-permeable plate.

11. A stormwater filter comprising:
a receptacle having an open top into which stormwater is permitted to enter the receptacle and flow downwardly therein, and the receptacle further including sidewalls and a bottom;
a hydroponic section defining an upper surface and including a media bed which is supported within the receptacle and in an elevated condition above the bottom thereof and wherein the media bed of the hydroponic section is capable of filtering stormwater which flows downwardly therethrough; and
wherein there is disposed between the hydroponic section and the bottom of the receptacle a water sump compartment; and
a sidewall of the receptacle defines a discharge opening disposed within the water sump compartment and adjacent the hydroponic section and the filter further includes means defining a post-filtration flow control orifice associated with the discharge opening for controlling the rate of filtration flow through the media bed; and
a wick is associated with the media bed of the hydroponic section and extends between the media bed and the water sump compartment for drawing water from the water sump compartment upwardly to the media bed for use by a plant growing in the media bed.

12. The filter as defined in claim 11 wherein the hydroponic section includes a filtration layer of perlite.

13. The filter as defined in claim 11 wherein the hydroponic section includes a combination of organic and inorganic filter media.

14. The filter as defined in claim 11 wherein the hydroponic section includes a layer of pea gravel which defines the upper surface of the hydroponic section.

15. The filter as defined in claim 11 wherein the wick has an upper section which is secured within the media bed and a lower section which extends downwardly into the water sump compartment.

16. The filter as defined in claim 15 wherein the wick is one wick of a plurality of wicks associated with the media bed of the hydroponic section, and the number of wicks of the filter corresponds to the amount of surface area of the media bed.

17. The filter as defined in claim 11 further comprising means defining a post-filtration flow control orifice which is associated with the discharge opening of the receptacle for controlling the filtration flow through the media bed.

18. The filter as defined in claim 11 wherein the means defining the post-filtration flow control orifice is in the form of a flow control plate which is arranged in a substantially vertical plane adjacent the discharge opening, and the flow control plate defines an opening therein of substantially semi-circular shape.

19. The filter as defined in claim 11 further including a rigid, water-permeable plate which is supported across the receptacle and above the water sump compartment, and the hydroponic section is positioned atop the rigid, water-permeable plate.

20. A stormwater filter system comprising:
a receptacle having an open top into which stormwater is permitted to enter the receptacle and flow downwardly therein, and the receptacle further including sidewalls and a bottom;
a hydroponic section defining an upper surface and including a media bed which is supported within the receptacle and in an elevated condition above the bottom thereof and wherein the media bed of the hydroponic section includes a bed of filter media which is capable of filtering stormwater which flows downwardly therethrough; and
wherein there is disposed between the hydroponic section and the bottom of the receptacle a water sump compartment within which stormwater is collected after flowing downwardly through the filter media of the hydroponic section; and
a sidewall of the receptacle defines a discharge opening disposed within the water sump compartment and adjacent the hydroponic section, and the filter further includes means defining a post-filtration flow control orifice for controlling the filtration flow through the media bed; and
the hydroponic section includes a wick which extends between the interior of the media bed and the water sump compartment for drawing water from the water sump compartment upwardly to the interior of the media bed.
